(19) United States
(12) Patent Application Publication
(10) Pub. No.: US 2018/0235829 A1
(43) Pub. Date: Aug. 23, 2018

(54) UPPER-LIMB EXERCISING DEVICE OF A TYPE WORN ON THE BODY

(71) Applicant: KOREA UNIVERSITY OF TECHNOLOGY AND EDUCATION INDUSTRY-UNIVERSITY COOPERATION FOUNDATION, Cheonan (KR)

(72) Inventors: Jee-Hwan Ryu, Cheonan (KR); Popov Dmitry, Cheonan (KR); Gaponov Igor, Cheonan (KR); Seung Jun Lee, Cheonan (KR)

(73) Assignee: KOREA UNIVERSITY OF TECHNOLOGY AND EDUCATION INDUSTRY-UNIVERSITY COOPERATION FOUNDATION, Cheonan (KR)

(21) Appl. No.: 15/549,375

(22) PCT Filed: Feb. 11, 2015
(86) PCT No.: PCT/KR2015/001369

§ 371 Date: Aug. 7, 2017

(51) Int. Cl. A61H 1/02; A63B 21/00; A63B 23/12; A63B 23/035

(52) U.S. Cl. CPC A61H 1/0281; A63B 21/00181; A61H 2201/1207; A63B 23/03508; A63B 23/12; A61H 2201/5053; A61H 2201/0192

(57) ABSTRACT

A wearable upper-limb exercise device according to the present invention includes: a drive unit which is configured to be wearable on a user's back and generates driving power; a support unit which is configured to be wearable on the user's shoulder; an upper-limb bending and stretching unit which is configured to be wearable on the user's upper limb; and a power transmission unit which is connected to the upper-limb bending and stretching unit via the support unit from the drive unit, and controls the upper-limb bending and stretching unit in accordance with the driving power of the drive unit so as to bend or stretch the user's upper limb.

### TECHNICAL FIELD

The present invention relates to an upper-limb exercise device for rehabilitating patients, and more particularly, to a wearable upper-limb exercise device which may be easily worn on a body, thereby minimizing exposure and increasing exercise efficacy.

### BACKGROUND ART

Recently, to keep up with the welfare improvement and the development on industries aimed for aged people, various assistive devices used for old and weak persons and disabled persons are being actively researched and developed.

Among the various assistive devices, an assistive exercise device for assisting in exercising a part of the body is particularly and most widely being researched because of the necessity of and demand for the assistive exercise device, and the assistive exercise device is actually being applied and used in a lot of medical and welfare facilities nowadays.

However, there is a problem in that the assistive exercise device in the related art is excessively larger in volume than needed to achieve the simple purpose of assisting in the motion of the body. Therefore, a space occupied by the assistive exercise device is increased, and mobility of the assistive exercise device significantly deteriorates, which causes inconvenience for a user because the user necessarily uses the assistive exercise device only at a designated place.

This inconvenience is a factor that greatly affects rehabilitation that requires a ceaseless treatment, and inevitably acts as a burden on the user with reduced mobility

Accordingly, there is a need for a method for solving the aforementioned problems.

### DISCLOSURE

### Technical Problem

The present invention has been made in an effort to solve the aforementioned problems in the related art, and an object of the present invention is to provide an upper-limb exercise device which may have a minimized volume and may be used in a state in which the upper-limb exercise device is worn directly on a user's body.

Another object of the present invention is to provide an upper-limb exercise device capable of obtaining more improved exercise efficacy in comparison with the related art.

Technical problems of the present invention are not limited to the aforementioned technical problems, and other technical problems, which are not mentioned above, may be clearly understood by those skilled in the art from the following descriptions.

### Technical Solution

To achieve the aforementioned objects, a wearable upper-limb exercise device according to the present invention includes: a drive unit which is configured to be wearable on a user's back and generates driving power; a support unit which is configured to be wearable on the user's shoulder; an upper-limb bending and stretching unit which is configured to be wearable on the user's upper limb; and a power transmission unit which is connected to the upper-limb bending and stretching unit via the support unit from the drive unit, and controls the upper-limb bending and stretching unit in accordance with the driving power of the drive unit so as to bend or stretch the user's upper limb.

Further, the drive unit may include: a main actuator which transmits the driving power to the power transmission unit; and a drive frame which is mounted on the user's body and fixes the main actuator.

In addition, the support unit may include: a support frame which is mounted on the user's shoulder; and a support member which is provided on an upper surface of the support frame and supports a part of the power transmission unit.

Further, the support frame may be formed to have a curved surface that surrounds the user's shoulder.

In addition, the power transmission unit may include: a first power transmission member which extends toward a lateral side of the user's upper arm; and a second power transmission member which extends toward a front side of the user's upper arm, and the upper-limb bending and stretching unit may include: a first upper arm fixing portion which is connected to the first power transmission member and surrounds the user's upper arm; and a second upper arm fixing portion which is connected to the second power transmission member and surrounds the user's upper arm.

Further, the upper-limb bending and stretching unit may further include: an auxiliary actuator which is provided on the first upper arm fixing portion at a front side of the user's upper arm; and a forearm fixing unit which surrounds the user's forearm, and the second power transmission member may be connected to the forearm fixing unit via the auxiliary actuator.

In addition, the upper-limb bending and stretching unit may further include a position fixing unit which is configured to surround the user's wrist and connected to the forearm fixing unit to fix a position of the forearm fixing unit.

Further, a first wire and a second wire may be provided in parallel with each other in multiple rows in at least a partial section of the first and second power transmission members, and the first wire and the second wire may be twisted by a rotation of the drive unit to change a length of the corresponding section, such that the upper-limb bending and stretching unit is controlled.

### Advantageous Effects

The wearable upper-limb exercise device according to the present invention for achieving the aforementioned objects has the following effects.

First, since the wearable upper-limb exercise device may be worn directly on the user's body, usability of the wearable upper-limb exercise device may be greatly improved.

Second, various degrees of freedom of the motion of the upper limb may be implemented by the support unit on the shoulder only by using a minimum occupied space.

Third, the wearable upper-limb exercise device may be mounted in the garment such that the wearable upper-limb exercise device may not be exposed to the outside, thereby satisfying the user's intention when the user does not want to expose his/her disability.

The effects of the present invention are not limited to the aforementioned effects, and other effects, which are not mentioned above, will be clearly understood by those skilled in the art from the claims.

### DESCRIPTION OF DRAWINGS

FIG. 1 is a perspective view illustrating an entire appearance of a wearable upper-limb exercise device according to an exemplary embodiment of the present invention.

FIG. 2 is a perspective view schematically illustrating a state in which the wearable upper-limb exercise device according to the exemplary embodiment of the present invention is operated.

FIGS. 3 and 4 are views illustrating a drive mechanism of a drive unit in the wearable upper-limb exercise device according to the exemplary embodiment of the present invention.

FIG. 5 is a perspective view illustrating an appearance of a support unit in the wearable upper-limb exercise device according to the exemplary embodiment of the present invention.

FIG. 6 is a perspective view illustrating a state in which a height of a support member is changed in the wearable upper-limb exercise device according to the exemplary embodiment of the present invention.

FIG. 7 is a perspective view illustrating an appearance of an upper-limb bending and stretching unit in the wearable upper-limb exercise device according to the exemplary embodiment of the present invention.

### BEST MODE

Hereinafter, an exemplary embodiment of the present invention for specifically accomplishing the objects of the present invention will be described with reference to the accompanying drawings. In the description of the present exemplary embodiment, like terms and like reference numerals are used for like configurations, and additional descriptions for the like configurations will be omitted.

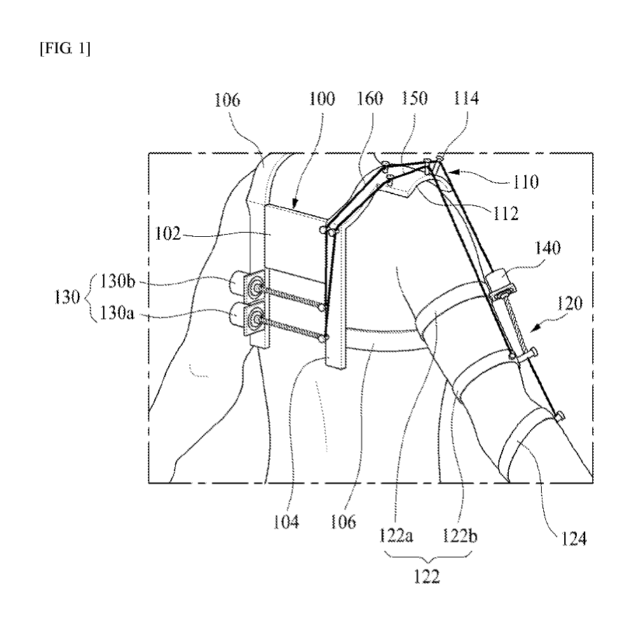

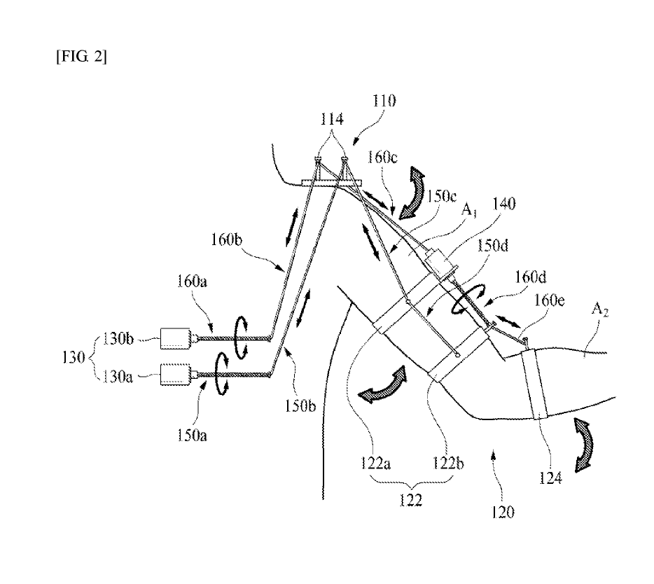

FIG. 1 is a perspective view illustrating an entire appearance of a wearable upper-limb exercise device according to an exemplary embodiment of the present invention, and FIG. 2 is a perspective view schematically illustrating a state in which the wearable upper-limb exercise device according to the exemplary embodiment of the present invention is operated.

As illustrated in FIGS. 1 and 2, a wearable upper-limb exercise device according to an exemplary embodiment of the present invention includes a drive unit 100, a support unit 110, an upper-limb bending and stretching unit 140, and power transmission units 150 and 160.

The drive unit 100 is a constituent element which is configured to be wearable on the user's back and generates driving power. In the present exemplary embodiment, the drive unit 100 includes a main actuator 130 which transmits driving power to the power transmission units 150 and 160, and a drive frame 104 which is mounted on the user's body and fixes the main actuator 130. In the present exemplary embodiment, the main actuator 130 includes a first actuator 130a and a second actuator 130b.

Further, the drive frame 104 is in close contact with the user's body through a fixing frame 106, and in this case, the drive frame 104 and the fixing frame 106 may be made of a flexible material in order to allow the user to conveniently wear the wearable upper-limb exercise device. Specifically, in the present exemplary embodiment, the fixing frame 106 is formed in the form of a band for surrounding the user's thoracic region and the user's shoulder.

In addition, in the present exemplary embodiment, the drive unit 100 may further include a battery 102. The battery 102 is configured to supply electric power to the main actuator 130 and an auxiliary actuator 140 to be described below. The battery 102 may be replaced or recharged.

The support unit 110 is configured to be wearable on the user's shoulder, and the support unit 110 defines a support shaft for changing a direction of force by allowing the power transmission units 150 and 160 to pass through the support unit 110.

In the present exemplary embodiment, the support unit 110 includes a support frame 112 which is mounted on the user's shoulder, and support members 114 which are provided on an upper surface of the support frame 112 and partially support the power transmission units 150 and 160.

In this case, the support frame 112 is formed to have a curved surface that surrounds the user's shoulder, thereby improving wearing comfort. In addition, the support members 114 protrude to change directions of the power transmission units 150 and 160.

Meanwhile, the power transmission units 150 and 160 include a first power transmission member 150 which extends toward a lateral side of the user's upper arm, and a second power transmission member 160 which extends toward a front side of the user's upper arm. That is, the power transmission units 150 and 160 may implement various motions of the upper limb by using the plurality of power transmission members.

Specifically, the first power transmission member 150 induces the user's upper arm to be stretched in a left and right direction, and the second power transmission member 160 induces the user's upper arm to be rotated in a front and rear direction.

The motion may be achieved because the first and second power transmission members 150 and 160 are changed in the direction by the support unit 110 from the shoulder and then extend downward toward the upper limb.

The upper-limb bending and stretching unit 120 is configured to be wearable on the user's upper limb, and the other side of the first power transmission member 150 and the other side of the second power transmission member 160 are connected to the upper-limb bending and stretching unit 120. In this case, the upper-limb bending and stretching unit 120 includes an upper arm fixing unit 122 which surrounds the user's upper arm A1, and a forearm fixing unit 124 which surrounds the user's forearm A2.

Further, the upper arm fixing unit 122 includes, in detail, a first upper arm fixing portion 122a and a second upper arm fixing portion 122b. The first and second upper arm fixing portions 122a and 122b are connected to the first and second power transmission members 150 and 160.

As a result, with the operation of the drive unit 100, the power transmission units 150 and 160 control the upper-limb bending and stretching unit 120 to bend or stretch the user's upper limb.

Here, as illustrated in FIG. 2, the first and second power transmission members 150 and 160 may be divided into respective sections including first sections 150a and 160a from the main actuator 130 to the drive frame 104, second sections 150b and 160b from the drive frame 104 to the support unit 110, and third sections 150c and 160c from the support unit 120 to the upper arm fixing unit 122.

In addition, the second power transmission member 160 may further include a fourth section 160d and a fifth section 160e. This configuration is to bend or stretch the user's forearm A2 by using the forearm fixing unit 124.

In this case, in the present exemplary embodiment, lengths of the first sections 150a and 160a of the first and second power transmission members 150 and 160 and a length of the fourth section 160d of the second power transmission member 160 may be changed by the drive unit 100.

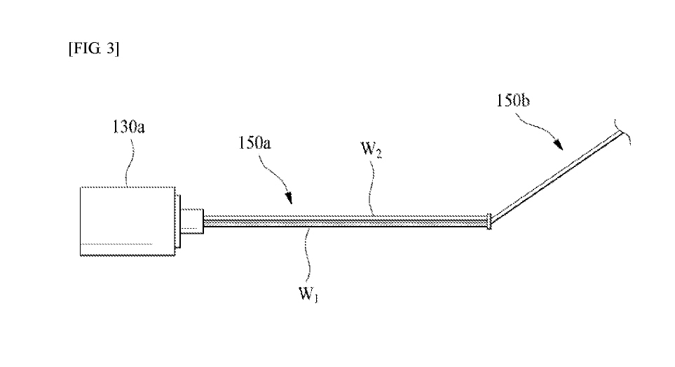

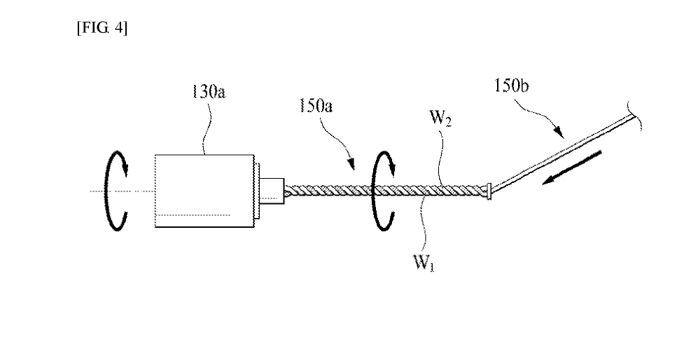

FIGS. 3 and 4 representatively illustrate the first section 150a of the first power transmission member 150, and it can be seen that a first wire W1 and a second wire W2 are arranged in parallel to each other in multiple rows in the first section 150a of the first power transmission member 150.

Further, the first wire W1 and the second wire W2 are twisted by the rotation of the first actuator 130a, such that an overall length of the first section 150a is decreased. As a result, the entire first power transmission member 150 is pulled, and the upper-limb bending and stretching unit 120 controls the user's upper limb.

The same applies to the first section 160a of the second power transmission member 160, and with the same principle, the fourth section 160d of the second power transmission member 160 may also control the user's forearm A2 by using the auxiliary actuator 140 which is provided on the first upper arm fixing portion 122a at the front side of the user's upper arm.

As described above, since all of the constituent elements of the present invention are provided to be adjacent to the user's body, the wearable upper-limb exercise device may be worn directly on the user's body or the garment, and as a result, it is possible to implement various degrees of freedom while greatly improving usability.

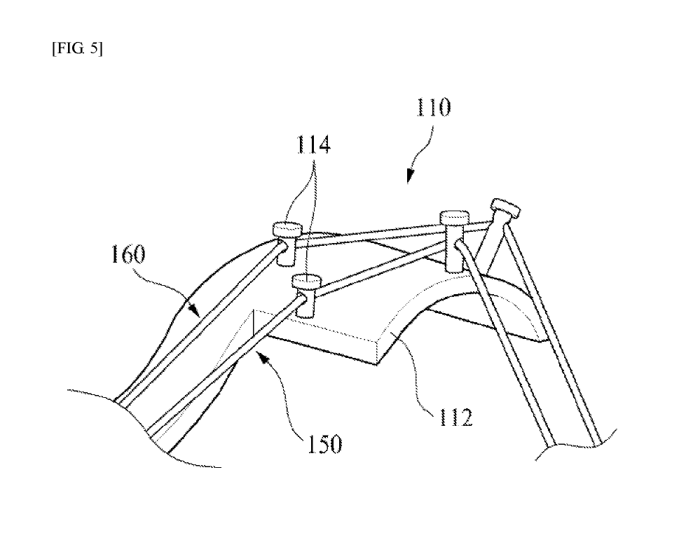

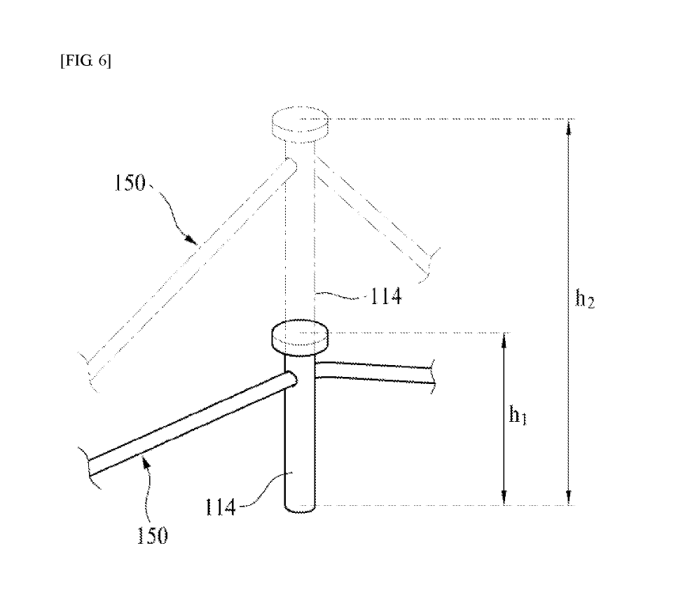

Meanwhile, FIG. 5 is a perspective view illustrating an appearance of the support unit 110 in the wearable upper-limb exercise device according to the exemplary embodiment of the present invention, and FIG. 6 is a perspective view illustrating a state in which a height of the support member 114 is changed in the wearable upper-limb exercise device according to the exemplary embodiment of the present invention.

As illustrated in FIGS. 5 and 6, the support members 114 convert the directions of the power transmission units 150 and 160 while supporting the power transmission units 150 and 160. In addition, if it is necessary to rapidly change angles of the power transmission units 150 and 160, the angles may be changed several times by the plurality of support members 114, and as a result, it is possible to prevent deterioration in usability.

Further, as illustrated in FIG. 6, it is possible to further improve driving torque if the height of the support member 114 is increased from a first height h1 to a second height h2. Therefore, the support members 114 having various lengths may be prepared and replaced, or the support member 114 may be configured to be autonomously adjustable in length.

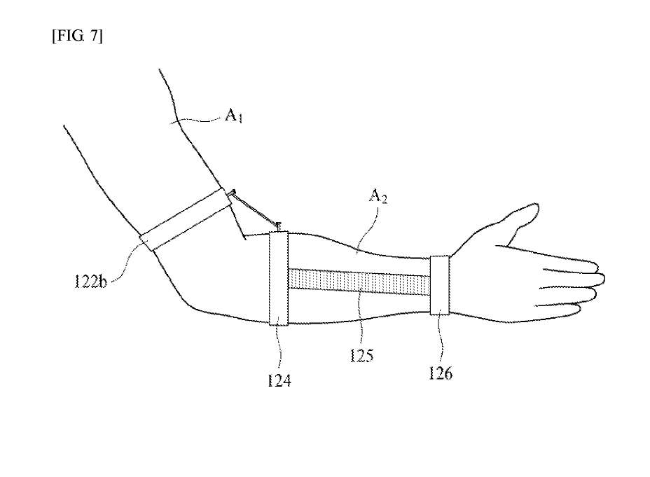

FIG. 7 is a perspective view illustrating an appearance of the upper-limb bending and stretching unit in the wearable upper-limb exercise device according to the exemplary embodiment of the present invention.

As illustrated in FIG. 7, in the present exemplary embodiment, the upper-limb bending and stretching unit is configured to surround the user's wrist, and may further include a position fixing unit 126 which is connected to the forearm fixing unit 124 and fixes a position of the forearm fixing unit 124.

The position fixing unit 126 serves to fix the forearm fixing unit 124 in order to prevent the position of the forearm fixing unit 124 from being changed by the power transmission units 150 and 160. In the present exemplary embodiment, the position fixing unit 126 and the forearm fixing unit 124 are connected to each other by a fixing strap 125, but the present invention is not limited thereto, and various fixing methods may of course be used.

While the exemplary embodiments according to the present invention have been described above, it is obvious to those skilled in the art that the present invention may be specified in other particular forms in addition to the aforementioned exemplary embodiments without departing from the spirit or the scope of the present invention. Accordingly, it should be understood that the aforementioned exemplary embodiments are not restrictive but illustrative, and thus the present invention is not limited to the aforementioned description, and may be modified within the scope of the appended claims and the equivalent range thereto.

1. A wearable upper-limb exercise device comprising:
a drive unit which is configured to be wearable on a user's back and generates driving power;
a support unit which is configured to be wearable on the user's shoulder;
an upper-limb bending and stretching unit which is configured to be wearable on the user's upper limb; and
a power transmission unit which is connected to the upper-limb bending and stretching unit via the support unit from the drive unit, and controls the upper-limb bending and stretching unit in accordance with the driving power of the drive unit so as to bend or stretch the user's upper limb.

2. The wearable upper-limb exercise device of claim 1, wherein the drive unit includes:
a main actuator which transmits the driving power to the power transmission unit; and
a drive frame which is mounted on the user's body and fixes the main actuator.

3. The wearable upper-limb exercise device of claim 1, wherein the support unit includes:
a support frame which is mounted on the user's shoulder; and
a support member which is provided on an upper surface of the support frame and supports a part of the power transmission unit.

4. The wearable upper-limb exercise device of claim 3, wherein the support frame is formed to have a curved surface that surrounds the user's shoulder.

5. The wearable upper-limb exercise device of claim 1, wherein the power transmission unit includes:
a first power transmission member which extends toward a lateral side of the user's upper arm; and
a second power transmission member which extends toward a front side of the user's upper arm, and
the upper-limb bending and stretching unit includes:
a first upper arm fixing portion which is connected to the first power transmission member and surrounds the user's upper arm; and
a second upper arm fixing portion which is connected to the second power transmission member and surrounds the user's upper arm.

6. The wearable upper-limb exercise device of claim 5, wherein the upper-limb bending and stretching unit further includes:
an auxiliary actuator which is provided on the first upper arm fixing portion at a front side of the user's upper arm; and
a forearm fixing unit which surrounds the user's forearm, and
the second power transmission member is connected to the forearm fixing unit via the auxiliary actuator.

7. The wearable upper-limb exercise device of claim 6, wherein the upper-limb bending and stretching unit further includes a position fixing unit which is configured to surround the user's wrist and connected to the forearm fixing unit to fix a position of the forearm fixing unit.

8. The wearable upper-limb exercise device of claim 5, wherein a first wire and a second wire are provided in parallel with each other in multiple rows in at least a partial section of the first and second power transmission members, and the first wire and the second wire are twisted by a rotation of the drive unit to change a length of the corresponding section, such that the upper-limb bending and stretching unit is controlled.
